(19) United States
(12) Patent Application Publication
(10) Pub. No.: US 2025/0211484 A1
(43) Pub. Date: Jun. 26, 2025

(54) ZONE AUTOMATIC CLEANUP SUPPORT ON FIBRE CHANNEL (FC) FABRICS

(71) Applicant: Cisco Technology, Inc., San Jose, CA (US)

(72) Inventors: Pritee Ghosh, Bangalore (IN); Sunil John Varghese, Bangalore (IN); Pramod Menon, Bangalore (IN); Harsha Bharadwaj, Bangalore (IN); Thangarasu Kumarasamy, Bangalore (IN)

(21) Appl. No.: 18/390,471

(22) Filed: Dec. 20, 2023

(51) Int. Cl. H04L 41/082; H04L 41/08; H04L 41/0893

(52) U.S. Cl. CPC H04L 41/082; H04L 41/0886; H04L 41/0893

(57) ABSTRACT

Systems and methods are provided for the automatic identification and cleanup of stale and inactive host-target flows for an active Fiber Channel (FC) fabric. FC modules are implemented within the FC fabric to automatically evaluate device disconnections and logical unit masking removals to detect stale and inactive host-target flows associated with the FC fabric. These stale and inactive host-target flows can be automatically removed from a zoning configuration for the FC fabric according to the configuration of associated zones.

### TECHNICAL FIELD

The present disclosure generally relates to the field of computer networking, particularly with regard to the automatic identification of zone configurations that include stale and inactive entries and to the automatic removal of such entries from the identified zone configurations.

### BACKGROUND

In Fibre Channel (FC) fabrics, zoning configuration is implemented to organize different devices into zones in order to facilitate communications amongst these different devices. For instance, for a set of devices (hosts/initiator devices and target devices/storage arrays), a zone is defined that enables communications amongst this set of devices. The different zones defined for an FC fabric are added to a zone set prior to activation. When the zone set is activated, switch hardware is programmed with Access Control List (ACL) entries to allow the network traffic between zoned devices only, thereby dropping any network traffic between devices that are not assigned to a zone at the ingress port. Since there can be a large number of devices in an FC fabric, the zoning configuration for the FC fabric can be large and can require constant updates as new devices are added to the FC fabric, older devices are removed from the FC fabric, and changes are made to any requirements.

The process to update a zoning configuration is often manual, which can be lengthy, tedious, and prone to error. Administrators of these FC fabrics seldom perform cleanup of any stale (e.g., zones containing offline devices) and inactive (e.g., devices within a zone that are no longer communicating) entries upon decommissioning of older devices from the FC fabrics. This results in a significant number of unused zoning configurations within FC fabrics. Further, having stale and inactive entries may make it more difficult to manage the FC fabrics and may result in new zone entries being denied as a result of scaling limitations. Further, these stale and inactive entries may add substantial Registered State Change Notification (RSCN) load on the FC fabrics. Thus, there is a need for the automatic detection and cleanup of stale and inactive entries from zoning configurations.

### BRIEF DESCRIPTION OF THE FIGURES

To provide a more complete understanding of the present disclosure and features and advantages thereof, reference is made to the following description, taken in conjunction with the accompanying drawings, in which:

FIGS. 1A-1B show an illustrative example of an environment in which stale and inactive flows are automatically identified from different zone configurations for an FC fabric in accordance with at least one embodiment;

FIG. 2 shows an illustrative example of a process for identifying stale entries corresponding offline devices within a zone in accordance with at least one embodiment;

FIG. 3 shows an illustrative example of an environment in which host behavior emulation is implemented to automatically detect Logical Unit Number (LUN) masking removal for the identification of inactive flows within a zone in accordance with at least one embodiment;

FIG. 4 shows an illustrative example of a process for detecting inactive flows within a zone in accordance with at least one embodiment;

FIG. 5 shows an illustrative example of a process for using FC analytics associated with a zone set to automatically detect inactive flows within the zone set in accordance with at least one embodiment;

FIG. 6 shows an illustrative example of an environment in which an active zone set configuration for an FC fabric is enumerated to all possible flows for monitoring of the possible flows and to detect any stale or inactive flows in accordance with at least one embodiment;

FIG. 7 shows an illustrative example of a process for identifying inactive flows through the use of flow state pointers in accordance with at least one embodiment;

FIG. 8 shows an illustrative example of a process for performing an automatic cleanup of a zone comprising a single target device and multiple host devices in accordance with at least one embodiment;

FIG. 9 shows an illustrative example of a process for performing an automatic cleanup of a zone comprising a single host device and multiple target devices in accordance with at least one embodiment;

FIG. 10 shows an illustrative example of a process for performing an automatic cleanup of a zone comprising multiple host devices and multiple target devices in accordance with at least one embodiment;

FIG. 11 illustrates an example network device suitable for performing switching, routing, and other networking operations in accordance with some embodiments; and

FIG. 12 illustrates a computing system architecture including various components in electrical communication with each other using a connection in accordance with some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Disclosed herein are systems and methods for automatically identifying and removing zone configurations that include stale and inactive entries for different FC fabrics.

In an example, a computer-implemented method comprises detecting disconnection of a device from a FC fabric. The FC fabric is associated with a zoning configuration. Further, the zoning configuration includes indications of devices configured to communicate within a zone. The computer-implemented method further comprises generating an update to the zoning configuration. The update includes a timestamp corresponding to a time at which the disconnection of the device was detected. The computer-implemented method further comprises determining that an expiration period corresponding to the disconnection has elapsed. The expiration period is defined according to the time at which the disconnection of the device was detected. The computer-implemented method further comprises determining that the disconnection of the device is not the result of a scheduled event. The computer-implemented method further comprises automatically removing an entry corresponding to the device from the zoning configuration.

In an example, the update further indicates a fabric port corresponding to the device. Further, the update is used to remove an FC identifier (FCID) entry corresponding to the device from the FC fabric.

In an example, the zone includes the device and another device within the FC fabric. The device and the other device form a host-target pair associated with the zone. Accordingly, the computer-implemented method further comprises automatically removing the zone from the zoning configuration.

In an example, the device is a target device associated with a host device from a plurality of host devices within the zone. Accordingly, the computer-implemented method further comprises automatically removing an entry corresponding to the host device from the zone.

In an example, the computer-implemented method further comprises determining that removing the entry from the zoning configuration results in the zone having a single target device within the zone. The computer-implemented method further comprises automatically removing the zone from the zoning configuration.

In an example, the computer-implemented method further comprises determining that all host devices associated with the zone are removable from the zone. The computer-implemented method further comprises automatically removing the zone from the zoning configuration.

In an example, the device is a host device associated with a set of target devices within the zone. Accordingly, the computer-implemented method further comprises removing the device from the zone as a result of a set of flows corresponding to the host device and the set of target devices being identified for removal.

In an example, a system comprises one or more processors and memory storing thereon instructions that, as a result of being executed by the one or more processors, cause the system to detect disconnection of a device from a FC fabric. The FC fabric is associated with a zoning configuration. Further, the zoning configuration includes indications of devices configured to communicate within a zone. The instructions further cause the system to generate an update to the zoning configuration. The update includes a timestamp corresponding to a time at which the disconnection of the device was detected. The instructions further cause the system to determine that an expiration period corresponding to the disconnection has elapsed. The expiration period is defined according to the time at which the disconnection of the device was detected. The instructions further cause the system to determine that the disconnection of the device is not the result of a scheduled event. The instructions further cause the system to automatically remove an entry corresponding to the device from the zoning configuration.

In an example, a non-transitory computer-readable storage medium stores thereon executable instructions that, as a result of being executed by one or more processors of a computer system, cause the computer system to detect disconnection of a device from a FC fabric. The FC fabric is associated with a zoning configuration. Further, the zoning configuration includes indications of devices configured to communicate within a zone. The executable instructions further cause the computer system to generate an update to the zoning configuration. The update includes a timestamp corresponding to a time at which the disconnection of the device was detected. The executable instructions further cause the computer system to determine that an expiration period corresponding to the disconnection has elapsed. The expiration period is defined according to the time at which the disconnection of the device was detected. The executable instructions further cause the computer system to determine that the disconnection of the device is not the result of a scheduled event. The executable instructions further cause the computer system to automatically remove an entry corresponding to the device from the zoning configuration.

### Description of Example Embodiments

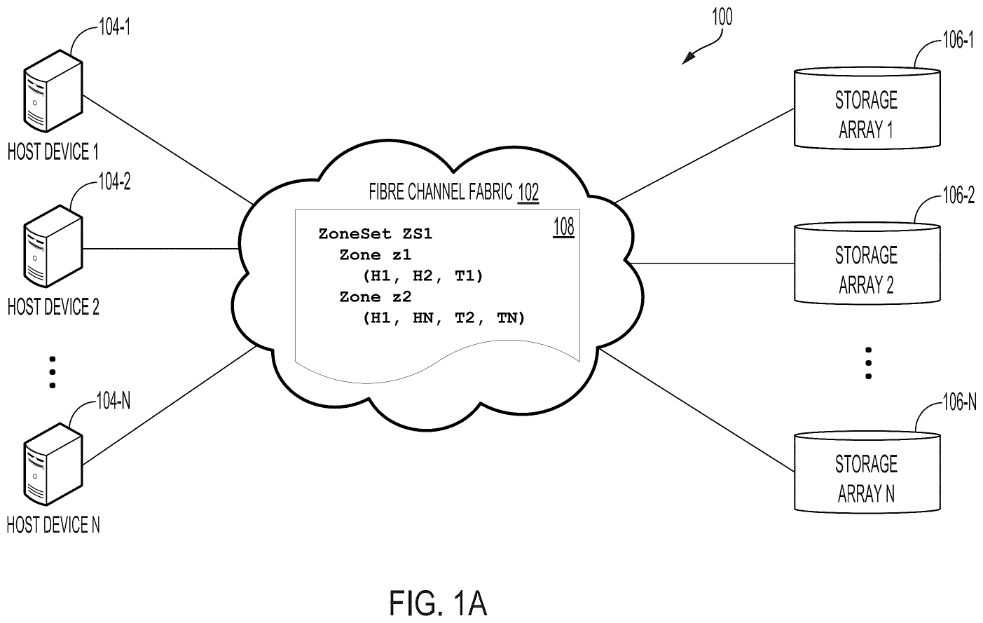

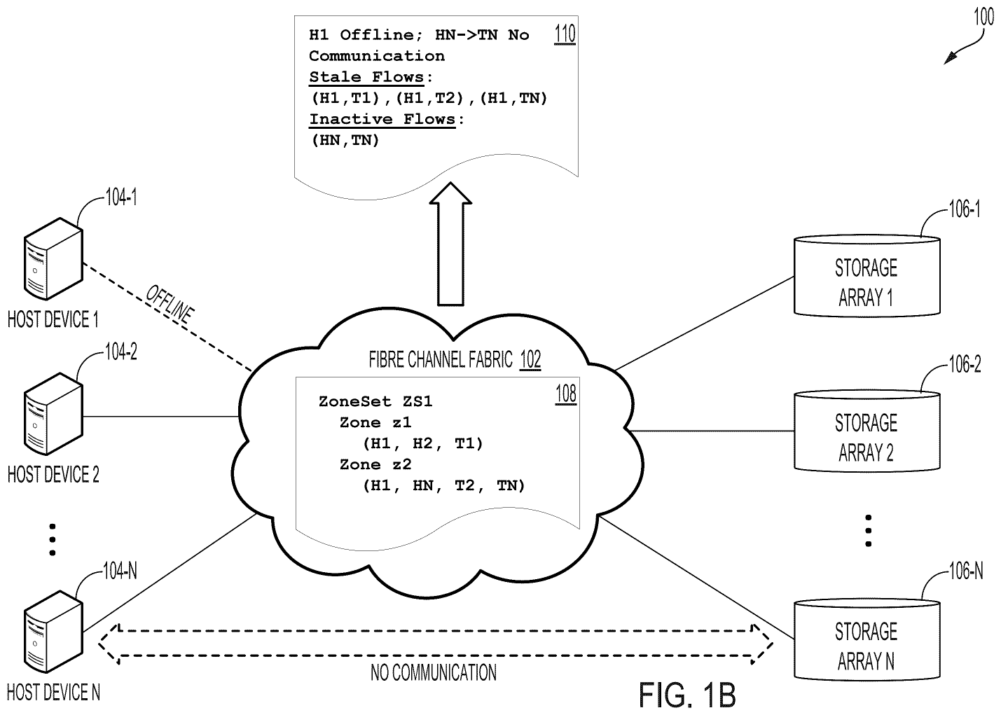

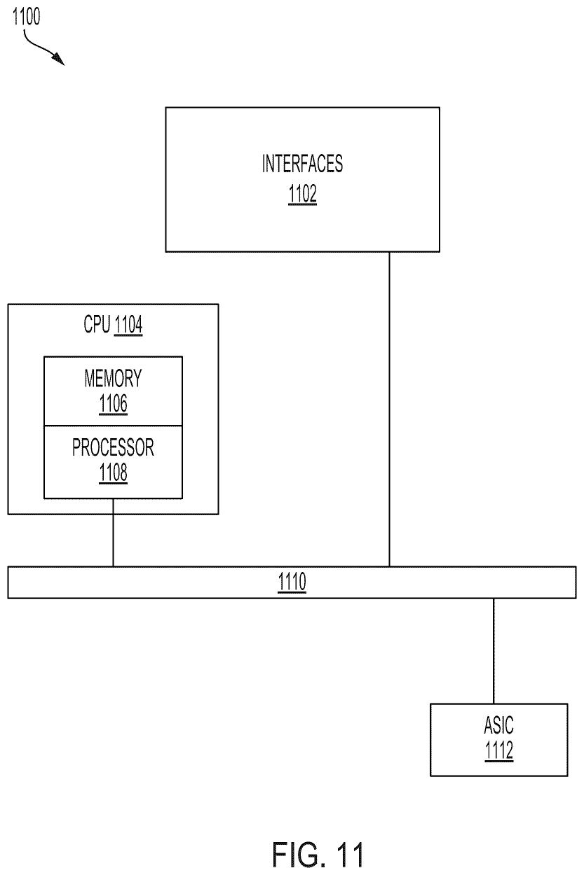

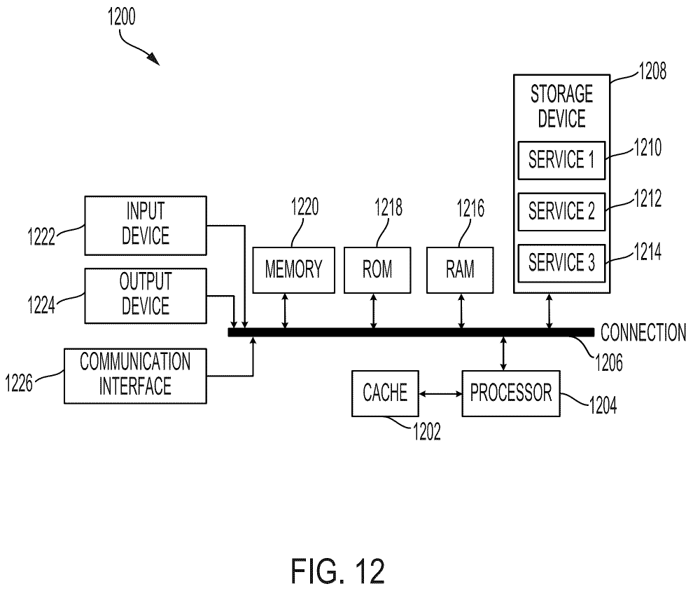

Disclosed herein are systems and methods for automatically identifying and removing zone configurations that include stale and inactive entries for different FC fabrics. The present technologies will be described in more detail in the following disclosure as follows. The discussion begins with a detailed description of example systems, processes and environments for performing the aforementioned determinations and predictions, as illustrated in FIGS. 1A-1B and 2 through 10. The discussion concludes with a description of an example network and computing devices, as illustrated in FIGS. 11 and 12.

FIGS. 1A and 1B show an illustrative example of an environment 100 in which stale and inactive flows are automatically identified from different zone configurations for an FC fabric in accordance with at least one embodiment. In the environment 100, and as illustrated in FIG. 1A, a Fibre Channel (FC) fabric 102 is implemented that includes a set of host devices (e.g., host devices 104-1 through 104-N) and a set of target devices (e.g., storage arrays 106-1 through 106-N). In an embodiment, the FC fabric 102 is partitioned into one or more zones that are organized into different zone sets. The definition of the one or more zones and the corresponding zone sets may be provided through a zoning configuration 108 associated with the FC fabric 102.

A zone associated with the FC fabric 102 may define the one or more host devices and target devices that can communicate with each other in the FC fabric 102. Additionally, for a given zone, access controls between different host devices and target devices may be defined. The FC fabric 102, through a zoning configuration 108, may maintain different zone sets that each include a set of zones for the FC fabric 102. Through a zone set, access controls can be enforced within the FC fabric 102 as only a single zone set may be active at any given time. Further, through a zone set, all zones within the zone set may be activated or deactivated as a single entity across all network switches in the FC fabric 102. Upon activation of the zone set, the network switches in the FC fabric 102 are programmed with Access Control List (ACL) entries to allow network traffic between the zoned devices only. Thus, these network switches, upon zone set activation, may automatically terminate any network traffic between devices not belonging to a zone within the zone set at the ingress port itself.

As illustrated in FIG. 1B, over time, different devices within the FC fabric 102 may go offline and different devices within a zone may stop communicating with each other. This may result in the zoning configuration 108 for the FC fabric 102 including one or more stale entries and/or inactive entries corresponding to these offline devices and to the devices no longer communicating with each other within a zone, respectively. As an illustrative example, and as illustrated through the listing 110, the host device 104-1 may be offline and there may be no communication between the host device 104-N and storage array 106-N. Accordingly, the zoning configuration 108 may include, for the active zone set, stale flows corresponding to the host device 104-1 (e.g., (H1, T1), (H1, T2), and (H1, TN), where H1 refers to host device 104-1 and T1 through TN refer to storage arrays 106-1 through 106-N, respectively). Further, the zoning configuration 108 may include, for the active zone set, an inactive flow corresponding to the zone pairing of host device 104-N and storage array 106-N (e.g., (HN, TN), where HN refers to host device 104-N and TN refers to storage array 106-N).

As noted above, the presence of stale and inactive entries within a zone configuration 108 for an FC fabric 102 may reduce the efficiency of the FC fabric 102 over time. For instance, as the number of stale and inactive entries increase over time, these existing zone databases associated with the FC fabric 102 may reach their corresponding database limits, making these databases more difficult to manage and resulting in an inability to add new entries to the zone databases. These stale and inactive entries may further occupy ternary content-addressable memory (TCAM) for ACL entries unnecessarily for devices which are not meant to communicate or have stopped communicating through the FC fabric 102. In some instances, having inactive entries within the zone configuration 108 may further add unnecessary RSCN load on the FC fabric 102.

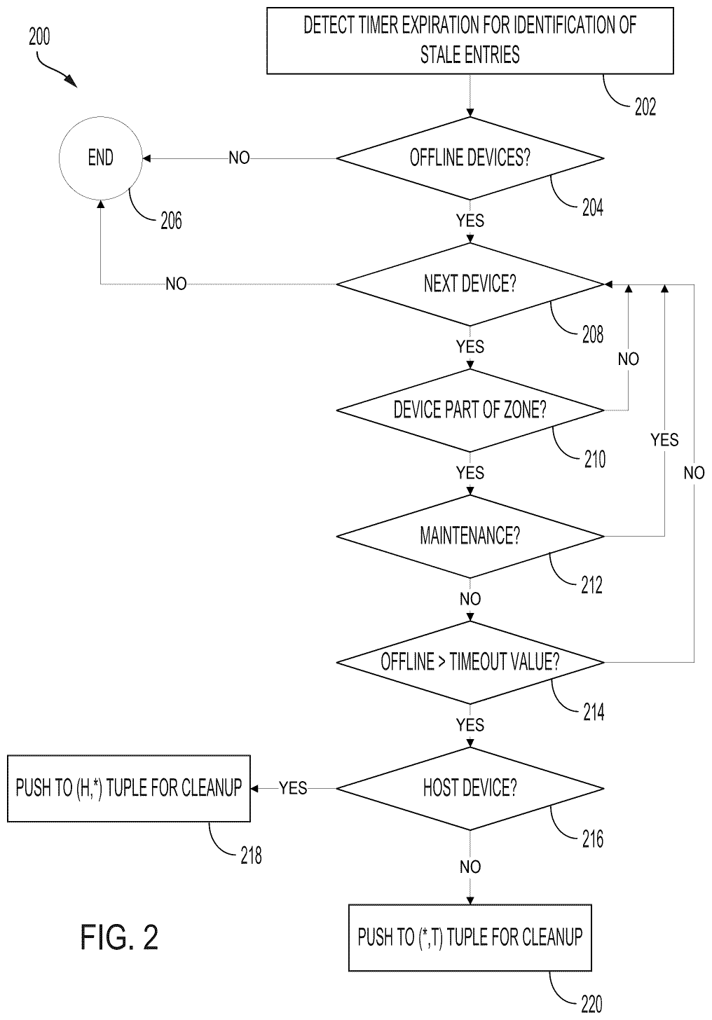

FIG. 2 shows an illustrative example of a process 200 for identifying stale entries corresponding offline devices within a zone in accordance with at least one embodiment. The process 200 may be performed periodically according to a timer for evaluation of the zoning configuration for a particular FC fabric. For instance, an administrator of the FC fabric may define, by default, a timer expiration period whereby once the time expiration period has elapsed, the process 200 may be performed for identifying stale entries from the zoning configuration. In some instances, this timer expiration period may be configurable such that an owner or other entity that maintains the FC fabric may determine the intervals for evaluating the zoning configuration to identify any stale entries that may be cleaned from the zoning configuration. The process 200 may be performed by a FC module implemented within the FC fabric.

At step 202, the FC module may automatically detect that the timer expiration period for the identification of stale entries associated with the FC fabric has elapsed. In an embodiment, the FC module implemented within the FC fabric implements a timer that defines the time interval for the evaluation of the zoning configuration associated with the FC fabric for the identification of stale entries. The time interval may be configurable, whereby an administrator of the FC fabric may define an amount of time for the time interval (e.g., 30 minutes, 1 hour, 2 hours, etc.). In some instances, the time interval for the timer may be pre-defined such that the time interval is fixed by default.

At step 204, once the timer expiration (e.g., time interval defined for the timer) has elapsed, the FC module may evaluate the zoning configuration to determine whether there are any offline devices associated with any of the entries specified in the zoning configuration. For instance, for each host-target device pairing flow indicated in the zoning configuration, the FC module may determine whether either or both of the host and target devices associated with the flow are disconnected from the FC fabric.

If the FC module determines that no devices indicated in the zoning configuration are offline, the FC module may determine that there are no stale entries within the zoning configuration. Accordingly, the process 200 may end at step 206. Once the process 200 has ended, the FC module may reset the timer and await expiration of the timer to restart the process 200 and identify any newly stale entries from the zoning configuration, as described herein.

If the FC module identifies a set of offline devices from the zoning configuration, the FC module may begin to evaluate each of these offline devices in order to identify any stale entries within the zoning configuration. For instance, the FC module may generate a list that indicates the set of offline devices detected by the FC module. Once this list is generated, the FC module, at step 208, may begin to evaluate each of the devices indicated in the list to identify the stale entries in the zoning configuration. If the FC module completes its evaluation of the different devices in the list, the process 200 may end at step 206. Further, the FC module may reset the timer and await expiration of the timer to restart the process 200 and identify any newly stale entries from the zoning configuration.

The FC module may evaluate the selected device from the list of offline devices to determine, at step 210, whether the selected device is a part of the particular zone for which stale entries are being identified. As noted above, the zoning configuration may be defined by organizing different devices into zones in order to facilitate communications amongst these different devices within the FC fabric. For instance, for a set of devices (hosts/initiator devices and target devices/storage arrays), a zone is defined that enables communications amongst this set of devices. The different zones defined for an FC fabric are added to a zone set, which may be indicated in the zoning configuration. For a given zone, the FC module may evaluate the zoning configuration to determine whether the selected device is a member of this zone. If the selected device is not a member of the given zone, the FC module may return to step 208 to select the next device from the list (if any) for evaluation.

In an embodiment, if the selected offline device is a part of the given zone, the FC module determines, at step 212, whether the selected offline device is offline as a result of scheduled maintenance. For instance, a device may be taken offline in order to perform maintenance, including updates and/or troubleshooting operations. Once the maintenance is performed, the device may be brought online at which point the device may need to communicate with other devices within the designated zone. Thus, a device that is designated as being under maintenance may not be subject to cleanup. In some instances, an option may be provided to administrators of the FC fabric to disable automatic removal of devices from zoning configurations for scheduled maintenance activities. Thus, the FC module determine, based on this option, whether the selected offline device is offline due to maintenance and, as a result, is not to be considered for automatic removal from the zoning configuration. If the selected offline device is offline due to maintenance, the FC module may return to step 208 to select the next device from the list (if any) for evaluation.

In an embodiment, if the selected offline device is not offline due to a scheduled maintenance, the FC module may determine whether the offline device has been offline for a period of time greater than a timeout threshold period. In an embodiment, when a device is offline, the FC module may generate an update about the FC fabric port where the device connects to ensure that the name server module removes the FC identifier (FCID) entry for the device from the FC fabric. On this same update, the timestamp corresponding to the time at which the device was detected as being offline is noted. The FC module may implement an offline timer which may be used to determine the amount of time that a device has been offline. Accordingly, using this offline timer, the FC module may determine whether the offline device has been offline for a period of time greater than a timeout threshold period. The timeout threshold period, in some instances, may be configurable (e.g., 7 days, 14 days, etc.) such that an administrator of the FC fabric may define when stale entries corresponding to offline devices may be removed from the zoning configuration. If an offline device has been offline for a period of time greater than this timeout threshold period, the offline device may be deemed to be offline permanently.

If the FC module determines that the selected offline device has not been offline the require amount of time, the FC module may select the next device from the list (if any) for evaluation, thus returning to step 208. However, if the FC module determines that the selected offline device has been offline for a period of time greater than the timeout threshold period, the FC module may determine that the offline device is permanently offline and, thus, can be cleaned from the zoning configuration. At step 216, the FC module may determine whether the offline device is a host device. If the FC module determines that the offline device is a host device within the zone, the FC module, at step 218, may push the (H,*) tuple corresponding to the host device for cleanup (where “H” denotes the identifier corresponding to the host device and “*” denotes a wildcard character such that all pairings including the host device are slated for cleanup). Alternatively, if the offline device is a target device within the zone (e.g., a storage array, etc.), the FC module may push the (*,T) tuple corresponding to the target device for cleanup (where “T” denotes the identifier corresponding to the target device and “*” denotes a wildcard character such that all pairings including the target device are slated for cleanup).

Once the FC module has pushed either the (H,*) tuple or the (*,T) tuple for the offline device for cleanup, the FC module may return to step 208 and determine whether there is a next device within the list. If there are additional offline devices indicated on the list, the FC module may continue to perform steps 210-220 of the process 200 until there are no more offline devices indicated in the list of offline devices. Once the FC module has exhausted the list of offline devices, the process 200 may end at step 206. Once the process 200 has ended, the FC module may await the expiration of the timer for identification of stale entries before restarting the process 200.

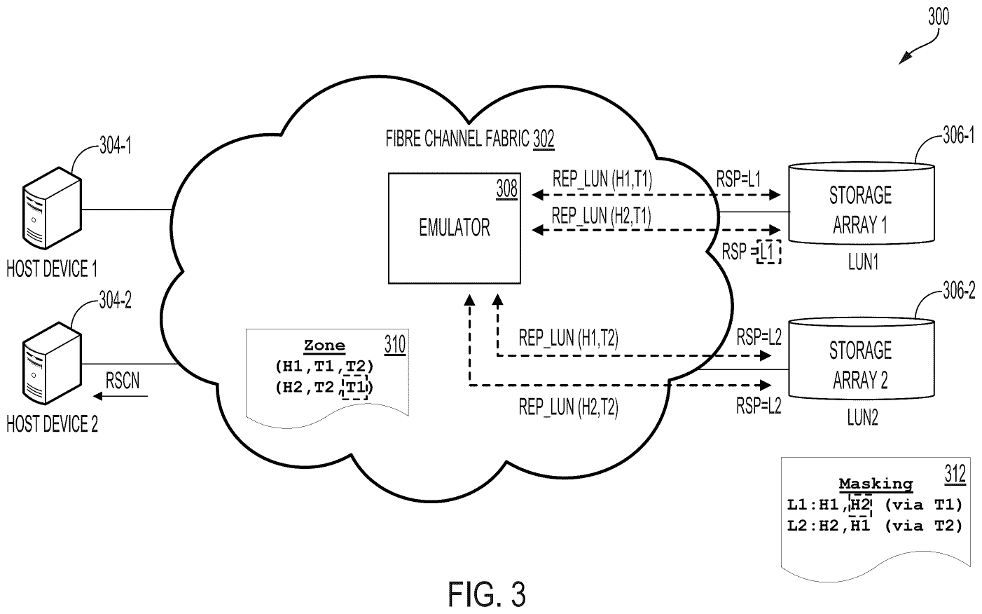

FIG. 3 shows an illustrative example of an environment 300 in which host behavior emulation is implemented to automatically detect LUN masking removal for the identification of inactive flows within a zone in accordance with at least one embodiment. In the environment 300, the end devices (e.g., host devices 304-1, 304-2 and storage arrays 306-1, 306-2) can communicate within the FC fabric 302 only when the zoning configuration 310 is present for these end devices on the FC fabric 302 and when LUN masking 312 is performed on the storage arrays 306-1, 306-2. LUN masking 312 may be performed by an administrator of the FC fabric 302 to ensure that only legitimate host devices can access assigned LUNs from the storage arrays 306-1, 306-2. When a host device and target device are not required to communicate anymore because of a change in an application's requirement, a cleanup of the zoning configuration 310 is required. Further, for this host device and target device, LUN masking needs to be removed from the storage arrays 306-1, 306-2.

In an embodiment, the FC fabric 302, through an FC switch, can automatically detect removal of LUN masking from storage arrays 306-1, 306-2 and perform the cleanup of the corresponding zoning configuration 310 from the FC fabric 302. In the FC fabric 302, the Small Computer System Interface (SCSI) REPORT_LUNS command is transmitted from an initiator port of a host device (such as either host device 304-1 or 304-2, as illustrated in FIG. 3) to a target device port on a storage array (such as either storage array 306-1 or 306-2) to request an inventory report of the LUNs that are accessible to the host-target (e.g., (H,T)) port pair. In response to this command, the receiving storage array may response with LUN masking information associated with the target device for the host device. Accordingly, the host device may determine the LUNs that it has access to.

In an embodiment, the FC switch within the FC fabric 302 may implement an emulator 308 that is configured to emulate a host device on the FC fabric 302 to automatically detect LUN masking removal. For instance, the emulator 308 may transmit a REPORT_LUNS command to the storage arrays 306-1, 306-2 as if the command was being sent by a host device in the FC fabric 302. The emulator 308 may further intercept and capture any responses provided by the storage arrays 306-1, 306-2. In an embodiment, to capture the correct responses and identify the active LUN entries, the emulator 308 uses a unique originator exchange identifier (OXID) field (e.g., OXID=0xFFFF) to differentiate the REPORT_LUNS command originating from the emulator 308 and the corresponding responses to the command from other commands and responses associated with an actual host device within the FC fabric 302.

In an embodiment, the emulator 308 processes the responses from the storage arrays 306-1, 306-2 that include the unique OXID field to determine whether these responses contain any LUN entries corresponding to an (H,T) pair flow. For instance, if the emulator 308 receives a response corresponding to a particular (H,T) pair flow that does not include any LUN entries, the emulator 308 may determine that the entry corresponding to the (H,T) pair flow in the zoning configuration 310 is fit for automatic cleanup, as this particular (H,T) pair flow may be inactive (e.g., there are no communications between the host and the target devices associated with the (H,T) pair flow. However, if the response corresponding to a particular (H,T) pair flow includes at least one LUN entry, the emulator 308 may determine that the particular (H,T) pair flow remains active.

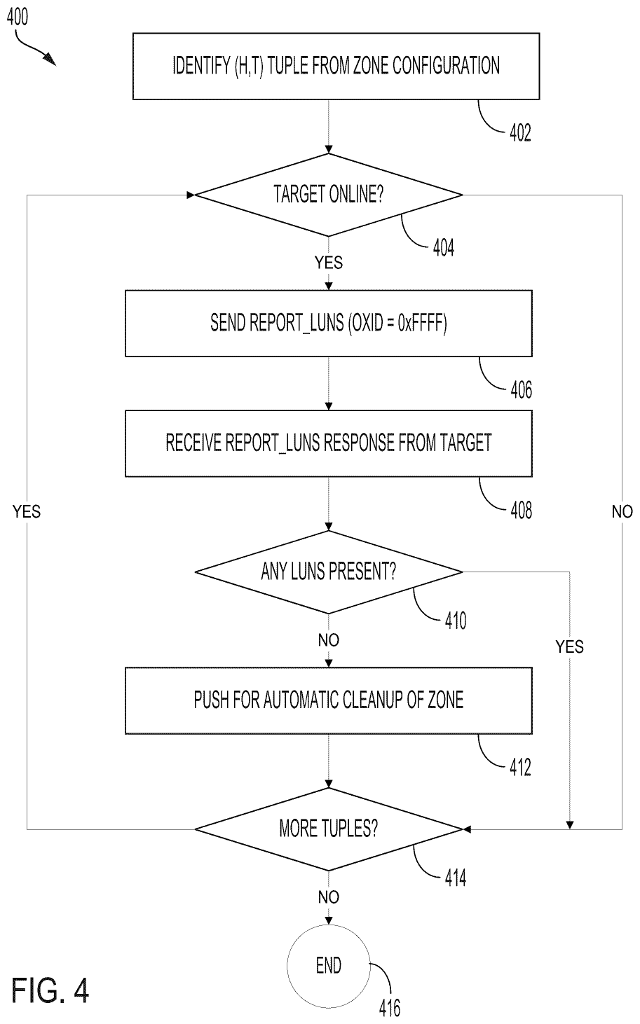

FIG. 4 shows an illustrative example of a process 400 for detecting inactive flows within a zone in accordance with at least one embodiment. The process 400 may be performed by an emulator that is configured to emulate a host device on the FC fabric to automatically detect LUN masking removal. At step 402, the emulator may identify an (H,T) tuple from the zone configuration for the FC fabric for evaluation. As noted above, the zone configuration may define different zones for a particular zone set, where a zone may include one or more host devices and target devices that can communicate with each other in the FC fabric. For a given zone, and using the zone configuration, the emulator may select a first (H,T) tuple corresponding to a host device and a target device (e.g., a storage array) for identification of inactive entries in the zone configuration.

At step 404, the emulator may determine whether the target device corresponding to the selected (H,T) tuple is online. If the target device is not online, the emulator, at step 414, may review the zoning configuration to determine whether there are any other (H,T) tuples that may be evaluated. If not, the process 400 ends at step 414. As noted above, if a target device is offline, this may denote the possible presence of stale entries within the zoning configuration. These stale entries corresponding to the offline target device may be identified by the FC module associated with the FC fabric through the process 200 described above in connection with FIG. 2. If there are no other (H,T) tuples remaining in the zoning configuration for evaluation, the process 400 may end at step 416.

If the target device associated with the selected (H,T) tuple is online, the emulator, at step 406, may send a REPORT_LUNS command to the target device. As noted above, to capture the correct responses and to identify any active LUN entries associated with the selected (H,T) tuple, the emulator may use a unique OXID field (e.g., OXID=0xFFFF) to differentiate the REPORT_LUNS command originating from the emulator and the corresponding responses to the command from other commands and responses associated with an actual host device within the FC fabric.

At step 408, the emulator may receive a REPORT_LUNS response from the target device associated with the selected (H,T) tuple. The emulator, at step 410, may evaluate the REPORT_LUNS response from the target device to determine whether there are any LUNs present within the response. If the REPORT_LUNS response from the target device includes one or more LUN entries, the emulator may determine that the (H,T) tuple is active. Accordingly, the emulator may forego adding the (H,T) tuple to a list of inactive flows for the zoning configuration, as communications may still be ongoing between the host device and the target device associated with the (H,T) tuple. The emulator may proceed to step 414 to determine whether there are any other (H,T) tuples in the zoning configuration for evaluation. If there are no other (H,T) tuples remaining in the zoning configuration for evaluation, the process 400 may end at step 416.

If the emulator determines that, for the selected (H,T) tuple and based on the response from the target device associated with the selected (H,T) tuple, that there are no LUN entries present in the response, the emulator may determine that the flow corresponding to the (H,T) tuple is inactive. Accordingly, at step 412, the emulator may push the (H,T) tuple for automatic cleanup of the corresponding zone such that the (H,T) tuple may be removed from the zoning configuration during the cleanup process for the zoning configuration, as described in greater detail herein. Once the emulator has pushed this (H,T) tuple for automatic cleanup of the corresponding zone, the emulator may determine, at step 414, whether there are any other (H,T) tuples in the zoning configuration for evaluation. If there are additional (H,T) tuples in the zoning configuration requiring evaluation, the emulator may repeat steps 404-412 for the next (H,T) tuple selected from the zoning configuration. However, if there are no other (H,T) tuples remaining in the zoning configuration for evaluation, the process 400 may end at step 416.

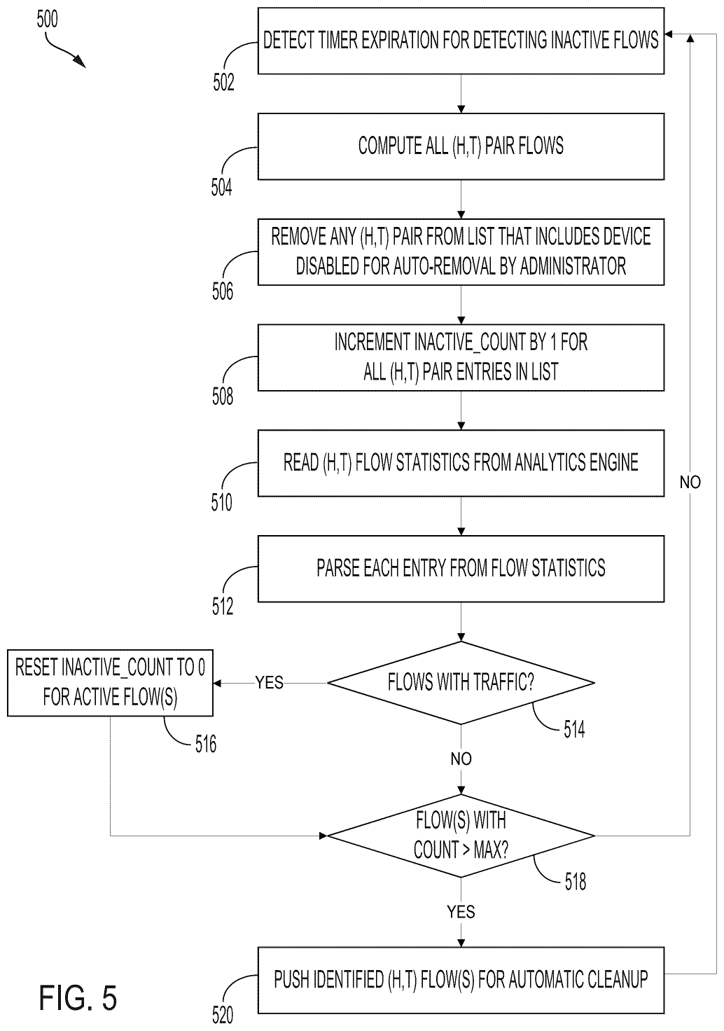

FIG. 5 shows an illustrative example of a process 500 for using FC analytics associated with a zone set to automatically detect inactive flows within the zone set in accordance with at least one embodiment. The process 500 may be performed by an FC module implemented on an FC fabric. In an embodiment, the process 500 is performed in instances where an administrator fails to cleanup LUN masking from storage arrays. In such instances, FC analytics for the FC switches in the FC fabric can be used to detect any inactive (H,T) flows within the FC fabric, as described in greater detail herein.

At step 502, the FC module may automatically detect that the timer expiration period for the identification of inactive flows associated with the FC fabric has elapsed. In an embodiment, the FC module implemented within the FC fabric implements a timer that defines the time interval for the evaluation of the zoning configuration associated with the FC fabric for the identification of inactive flows. The time interval may be configurable, whereby an administrator of the FC fabric may define an amount of time for the time interval (e.g., 30 minutes, 1 hour, 2 hours, etc.). In some instances, the time interval for the timer may be pre-defined such that the time interval is fixed by default.

At step 504, the FC module may compute all active (H,T) pair flows from the zoning configuration. The FC module may enumerate the active zone set from the zoning configuration for all possible (H,T) pair flows. The FC module may obtain, for each (H,T) pair flow, FC analytics data that may be used to determine whether the (H,T) pair flow is active or inactive, as described in greater detail herein. For any (H,T) pair flow specified in the zoning configuration but not included in the enumerated list of active (H,T) pair flows, the FC module may push the (H,T) pair flow to the enumerated list for evaluation. Further, for any new (H,T) pair flows added to the enumerated list, the FC module may set an inactivity count to zero to indicate that the newly added (H,T) pair flow is being labeled as newly inactive.

At step 506, the FC module may remove any (H,T) pair flow from the enumerated list that includes a device that is offline or marked as disabled for automatic removal by an administrator of the FC fabric. For instance, an (H,T) pair flow may become stale as a result of either a host device or target device (e.g., storage array) being offline. The device may be offline due to a maintenance event, as defined by the administrator and after which the device may be brought back online. Thus, automatic removal of the (H,T) pair flow may not be warranted.

At step 508, the FC module may increment the inactive count for each of the remaining (H,T) pair flows in the enumerated list by one. Each increment may correspond to the length of time corresponding to the timer used to initiate the process 500 for the identification of inactive flows. For example, if the process 500 is performed every 30 minutes (where the timer for performing the process 500 is set to 30 minutes), each increment of the inactive count may equal a 30 minute time interval during which the corresponding (H,T) flow was inactive.

At step 510, the FC module may read the (H,T) pair flow statistics from the analytics engine associated with the FC fabric and for each of the (H,T) pair flows in the enumerated list. As noted above, the FC module may obtain, for each (H,T) pair flow, FC analytics data that may be used to determine whether the (H,T) pair flow is active or inactive. The FC analytics engine may collect performance and error metrics by inspecting data frames on switch ports. The engine may monitor flows bi-directionally, correlate the (H,T) pair flows in a network processing unit (NPU) or natively in the application-specific integrated circuit (ASIC) within the FC module, and provide the analyzed network data. The FC analytics engine may push the performance and error metrics to the FC module after each configured time interval (e.g., the timer period). These metrics may be displayed on the FC switch through command line interfaces (CLIs) as well as pushed out to upstream receivers (e.g., Data Center Network Manager (DCNM), Nexus Dashboard, etc.) through telemetry streaming. The (H,T) pair flow metrics tracked and computed by the FC analytics engine may include active I/O read counts and active I/O write counts.

At step 512, the FC module may parse each (H,T) pair flow entry from the enumerated list according to the obtained FC analytics data. Through the parsing of each pair flow, the FC module, at step 514, may determine whether there are any (H,T) pair flows for which there is still network traffic between the corresponding host and target devices. If the FC module identifies an (H,T) pair flow for which there is still network traffic between the corresponding host device and target device, the FC module, at step 516, may reset the inactivity count for this (H,T) pair flow to zero as this (H,T) pair flow (based on the FC analytics data) is still active within the FC fabric.

If the FC module does not identify any active (H,T) flows from the enumerated list, or the FC module has completed resetting the inactivity count for the identified active (H,T) pair flows, the FC module may determine, at step 518, whether there are any (H,T) flows in the enumerated list that have an inactivity count greater than or equal to the maximum threshold inactivity count. In an embodiment, the FC module maintains a configured maximum threshold inactivity count for identifying (H,T) pair flows that can be deemed to be inactive permanently and, thus, can be automatically cleaned up from the zoning configuration. The maximum threshold inactivity count may be defined by an administrator of the FC fabric and, accordingly, may be modified by the administrator. In some instances, the maximum threshold inactivity count may be pre-defined, by default, by a provider of the FC fabric. For instance, the maximum threshold inactivity count may be initially defined as 4,320 (i.e., 2 counts/hour*24 hours/day*90 days=4,320 counts for a 90-day inactivity limit, etc.). Based on the amount of time for which a pair flow may be inactive, the FC module may compute the corresponding number of counts for the maximum threshold inactivity count.

If the FC module identifies an (H,T) pair flow that has an inactivity count greater than or equal to the maximum threshold inactivity count, the FC module, at step 520, may push the identified (H,T) pair flow for automatic cleanup from the zoning configuration. As noted above, when the inactivity count for an (H,T) pair flow is greater than or equal to the maximum threshold inactivity count, the FC module may automatically determine that this (H,T) pair flow is permanently inactive and, thus, may be removed from the zoning configuration. Thus, the FC module may push this (H,T) pair flow to an enumerated list of pair flows that may be removed from the zoning configuration. Once the FC module has completed its evaluation of the different (H,T) pair flows within the enumerated list and performed corresponding actions based on the respective inactivity counts, the FC module may await expiration of the aforementioned timer before restarting the process 500.

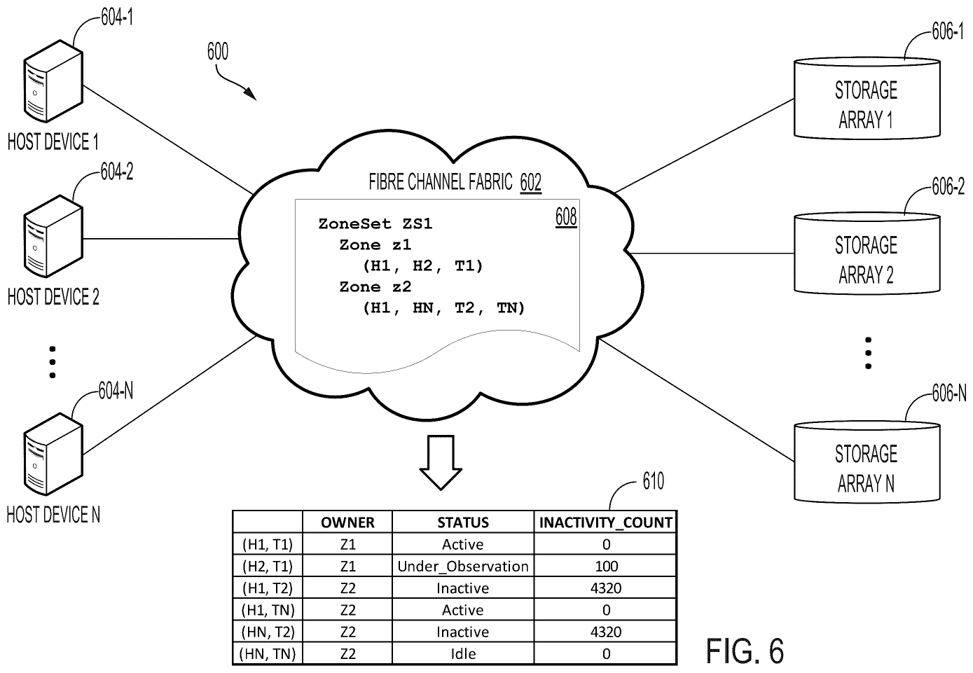

FIG. 6 shows an illustrative example of an environment 600 in which an active zone set configuration 608 for an FC fabric 602 is enumerated to all possible flows for monitoring of the possible flows and to detect any stale or inactive flows in accordance with at least one embodiment. In the environment 600, flow counters may be enabled for the identification of stale and inactive entries within a zoning configuration 608. For instance, an fcflow feature may be activated for the FC switches in the FC fabric 602 and where zoning entries in the ACL TCAM can have flow statistics pointers (e.g., counters) along with permit entry fields. This counter may be incremented whenever the corresponding zoning TCAM entry is hit to forward the data packet. Thus, the incremented pointer value may represent the active zoning flows.

In an embodiment, the FC module implemented in the FC fabric 602 may read the flow statistics pointer values at each timer interval (e.g., every 30 minutes, every hour, etc. as configured) to determine whether an (H,T) pair flow was hit during the timer interval. For instance, the FC module, at the expiration of the timer interval, may evaluate the enumerated list 610 of the (H,T) pair flows (e.g., pair flows corresponding to the different host devices 604-1 through 604-N and storage arrays 606-1 through 606-N within the FC fabric 602, etc.) to determine whether any of the (H,T) pair flows have been inactive for a period of time that is equal to or greater than a maximum threshold period of time. Any (H,T) pair flow identified as being inactive for a period of time greater than or equal to this maximum threshold period of time may be considered to be fit for automatic cleanup from the zoning configuration 608.

In some instances, there may be a limited number of dedicated flow statistics pointers per ASIC on FC switches. As a result, the FC module may only be able to monitor this limited number of (H,T) flows at a given time. While this limited number may be sufficient in some instances for monitoring all (H,T) flows for an FC fabric 602, there may be instances where the number of (H,T) flows exceeds this limitation. In such instances, the FC module may enumerate the active zoning configuration for all possible (H,T) pair flows with corresponding host devices and target devices (storage arrays) that may be online and that are not disabled from automatic cleanup (e.g., are offline due to scheduled maintenance, etc.). The FC module, in the enumerated list 610, may mark the status of each of these possible (H,T) pair flows as “IDLE.” Further, the FC module may mark the inactivity count for each of these possible (H,T) pair flows to zero.

In an embodiment, if the number of possible (H,T) flows exceeds the limited number of dedicated flow statistics points per ASIC on the FC switch for the FC fabric 602, the FC module may enable an equal limited number of entries from the number of possible (H,T) flows in the enumerated list 610. These entries may be marked as being “Under_Observation” in the enumerated list 610. At the end of a timer interval (e.g., every 30 minutes, etc.), the FC module may read the dedicated flow statistics pointers from the enumerated list 610 to determine whether any of these pointers have been incremented as a result of the corresponding (H,T) flow being hit as a result of data traffic. For any (H,T) flow that has had its flow statistics pointer incremented, the FC module may mark the (H,T) flow as having an “Active” status and the corresponding inactivity count for the (H,T) flow may be reset to zero. Additionally, the FC module may disable the (H,T) flow for the fcflow feature and free the corresponding flow statistics pointer. The FC fabric may enable the next set of (H,T) flows from the enumerated list 610 and assigned to the freed flow statistics pointers.

In an embodiment, for any (H,T) flow that did not have its corresponding flow statistics pointer incremented (e.g., the (H,T) flow was not hit within the timer interval), the FC module increments the inactivity count of the (H,T) flow by one. Additionally, the FC module may determine whether any of these identified (H,T) flows have an inactivity count that is greater than or equal to a maximum threshold inactivity count. As noted above, the maximum threshold inactivity count may be defined by an administrator of the FC fabric 602 and, accordingly, may be modified by the administrator. In some instances, the maximum threshold inactivity count may be pre-defined, by default, by a provider of the FC fabric 602. For instance, the maximum threshold inactivity count may be initially defined as 4,320 (i.e., 2 counts/hour*24 hours/day*90 days=4,320 counts for a 90-day inactivity limit, etc.). If the inactivity count for an (H,T) flow is greater than or equal to this maximum threshold inactivity count, the FC module may update the status of this (H,T) flow to “Inactive” in the enumerated list 610. Any (H,T) flow having an “Inactive” status is deemed to be fit for automatic cleanup from the zoning configuration 608.

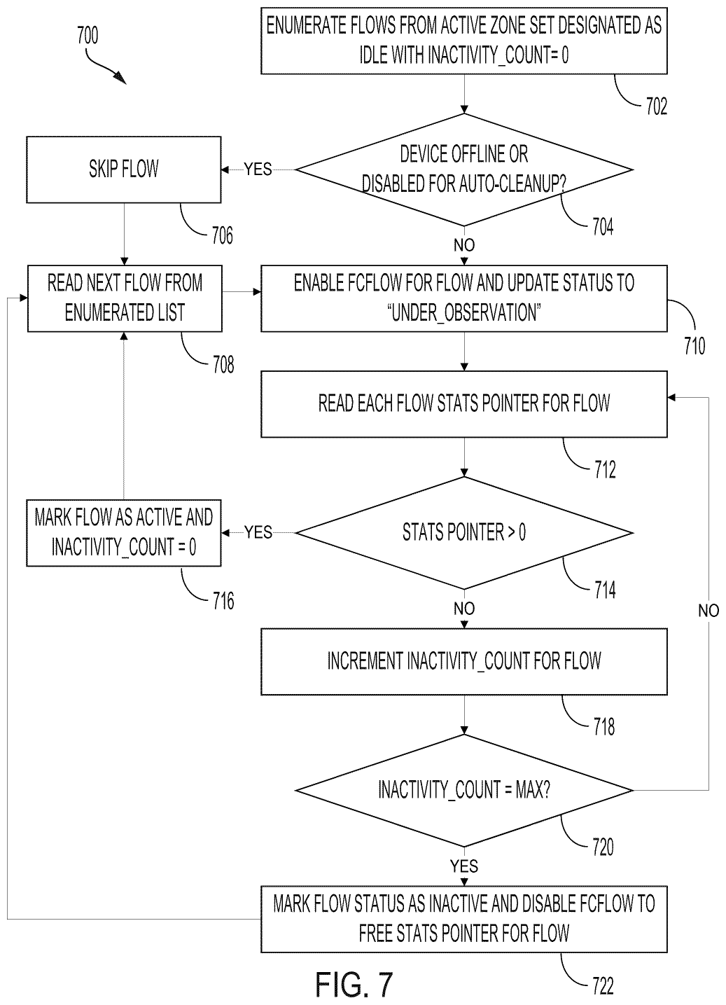

FIG. 7 shows an illustrative example of a process 700 for identifying inactive flows through the use of flow state pointers in accordance with at least one embodiment. The process 700 may be performed by an FC module implemented on an FC fabric. In an embodiment, the process 700 is performed in instances where an fcflow feature is activated for the FC switches in the FC fabric and where zoning entries in the ACL TCAM can have flow statistics pointers along with permit entry fields. The process 700 may be performed when a pre-defined timer has expired (e.g., every 30 minutes, every hour, etc. as configured by an administrator of the FC fabric or by default).

At step 702, the FC module may enumerate the (H,T) flows from the active zone set defined in the zoning configuration. Each of the (H,T) flows may be marked as “IDLE” for their status and have an initial inactivity count of zero. As noted above, there may be a limited number of dedicated flow statistics pointers per ASIC on FC switches. As a result, the FC module may only be able to monitor this limited number of (H,T) flows at a given time. While this limited number may be sufficient in some instances for monitoring all (H,T) flows for an FC fabric, there may be instances where the number of (H,T) flows exceeds this limitation. In such instances, the FC module may enumerate the active zoning configuration for all possible (H,T) pair flows with corresponding host devices and target devices that may be online and that are not disabled from automatic cleanup.

At step 704, the FC module may determine, for each enumerated (H,T) flow, whether any of the host device or the target device associated with the (H,T) flow is offline or has otherwise been disabled from automatic cleanup (e.g., the device is offline due to scheduled maintenance, etc.). As noted above, if a device is offline due to a maintenance event, as defined by the administrator, the device may be brought back online at a later time. Thus, automatic removal of the (H,T) flow corresponding to this device may not be warranted. Thus, if the FC module detects that a device from an enumerated (H,T) flow is offline or otherwise disabled from automatic cleanup, the FC module may skip this (H,T) flow at step 706 and read the next (H,T) flow from the enumerated list at step 708.

If the FC module determines that the neither device in the (H,T) flow is offline or otherwise disabled from automatic cleanup, the FC module, at step 710, may enable fcflow for the (H,T) flow (e.g., assigned a flow statistics pointer) and make the status of the (H,T) flow in the enumerated list as “Under_Observation.” At the end of a timer interval (e.g., every 30 minutes, etc.), the FC module, at step 712, may read the dedicated flow statistics pointers from the enumerated list to determine, at step 714, whether any of these pointers have been incremented as a result of the corresponding (H,T) flow being hit as a result of data traffic.

If an (H,T) flow has had its flow statistics pointer incremented as a result of the (H,T) having been hit due to data traffic within the flow, the FC module, at step 716, may mark the (H,T) flow as having an “Active” status. Further, the FC module may reset the corresponding inactivity count for the (H,T) flow to zero. The FC module may disable the (H,T) flow for the fcflow feature and free the corresponding flow statistics pointer. The FC fabric may enable the next set of (H,T) flows from the enumerated list and assign the freed flow statistics pointers to these flows. Once the FC module has performed step 716 for the active (H,T) flow, the FC module, at step 708, may read the next (H,T) flow from the enumerated list.

If the flow statistics pointer for the particular (H,T) flow has not been incremented (e.g., the (H,T) flow has not been hit, denoting a lack of data traffic within the flow), the FC module, at step 718, may increment the inactivity count for the (H,T) flow by one. As noted above, each increment of the inactivity count may denote a period of inactivity equal to the timer length used for detecting inactive flows (e.g., 30 minutes, an hour, etc.). Thus, as the number of increments increases, this may denote consecutive periods of inactivity for an (H,T) flow.

At step 720, the FC module may determine, for the (H,T) flow, whether the inactivity count is greater than or equal to the maximum threshold inactivity count (as defined by an administrator of the FC fabric or pre-defined, by default, by a provider of the FC fabric). If the FC module determines that the inactivity count for the (H,T) flow is not greater than or equal to the maximum threshold inactivity count, the FC module may reach the flow statistics pointer for the next (H,T) flow from the enumerated list, repeating steps 712-720 for this next (H,T) flow. However, if the FC module determines that the inactivity count for the (H,T) flow is greater than or equal to the maximum threshold inactivity count, the FC module may, at step 722, may mark the status of this (H,T) flow as “Inactive” in the enumerated list. As noted above, any (H,T) flow having an “Inactive” status may be deemed to be fit for automatic cleanup from the zoning configuration for the FC fabric. The FC module may further disable the (H,T) flow for the fcflow feature and free the corresponding flow statistics pointer. Once the FC module has performed step 722 for the inactive (H,T) flow, the FC module, at step 708, may read the next (H,T) flow from the enumerated list and repeat the steps 710-722 for the remaining enumerated (H,T) flows.

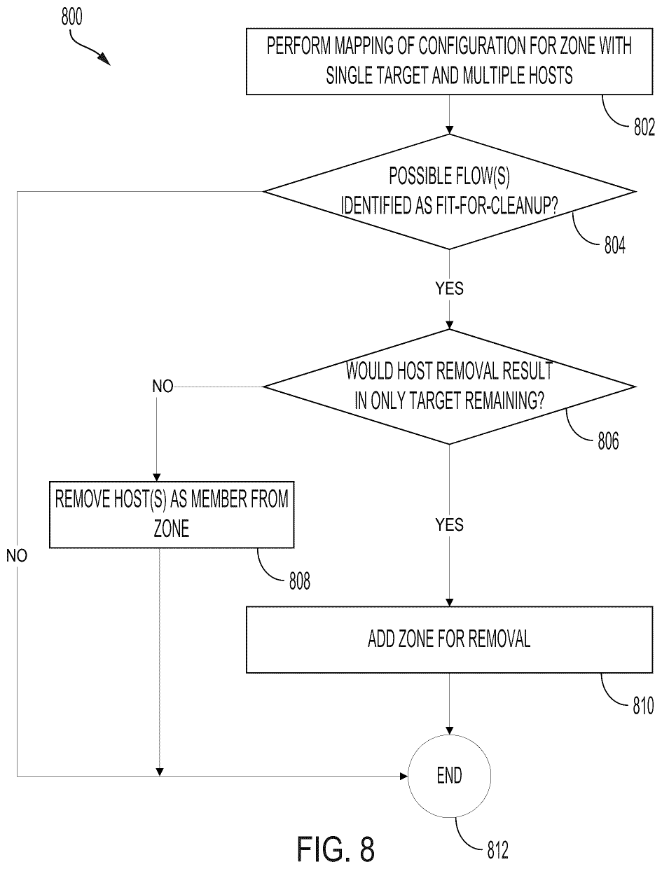

FIG. 8 shows an illustrative example of a process 800 for performing an automatic cleanup of a zone comprising a single target device and multiple host devices in accordance with at least one embodiment. The process 800 may be performed by any FC module associated with any of the edge switches in the FC fabric. These edge switches may be directly connected to the storage arrays (e.g., target devices) associated with the FC fabric. This process 800 is performed by the FC modules associated with these edge switches in order to prevent duplication of zoning configurations for the FC fabric. In an embodiment, the process 800 is performed upon expiration of a recurrent timer. This recurrent timer may be similar to the timers described above for the identification of stale and inactive flows from the zoning configuration. For instance, as the processes described above in connection with FIGS. 2, 4-5, and 7 are completed in response to expiration of the recurrent timer, the FC module may subsequently perform the process 800 for cleanup of the zoning configuration.

At step 802, the FC module may perform a mapping of the zoning configuration for a zone having a single target and multiple hosts. Through this mapping, the FC module may evaluate the zoning configuration to potentially identify any (H,T) flow pairs that have been identified as being fit-for-cleanup in the zone containing a single target device (e.g., storage array) and multiple host devices. These (H,T) flow pairs may be identified as being fit-for-cleanup through any of the processes described above in connection with FIGS. 2, 4-5, and 7. For instance, an (H,T) flow may be identified as being fit-for-cleanup as a result of the flow being classified as being either stale or inactive within the zoning configuration.

At step 804, the FC module may determine, based on the mapping, whether there are any possible (H,T) flows identified as being fit-for-cleanup. If there are no possible (H,T) flows identified as being fit-for-cleanup (e.g., no flow in the mapping has been designated as being fit-for-cleanup), the process 800 may end at step 812. However, if the FC module determines that there is at least one possible (H,T) flow that is identified as being fit-for-cleanup, the FC module, at step 806, may determine whether removal of the one or more host devices associated with these possible (H,T) flows would result in the zone containing only the target device.

If the FC module determines that removal of the possible (H,T) flows would result in the zone including the single target device and at least one host device, the FC module, at step 808, may remove the one or more hosts associated with the identified (H,T) flows from the zone in the zoning configuration. Alternatively, if the FC module determines that removal of the possible (H,T) flows would result in the target device being the sole member of the zone (e.g., no host devices would remain within the zone), the FC module may instead, at step 810, add the zone for removal from the zoning configuration as opposed to the individual host devices associated with the zone. Once the FC module has identified the hosts or the entire zone for removal from the zoning configuration, the process 800 may end at step 812.

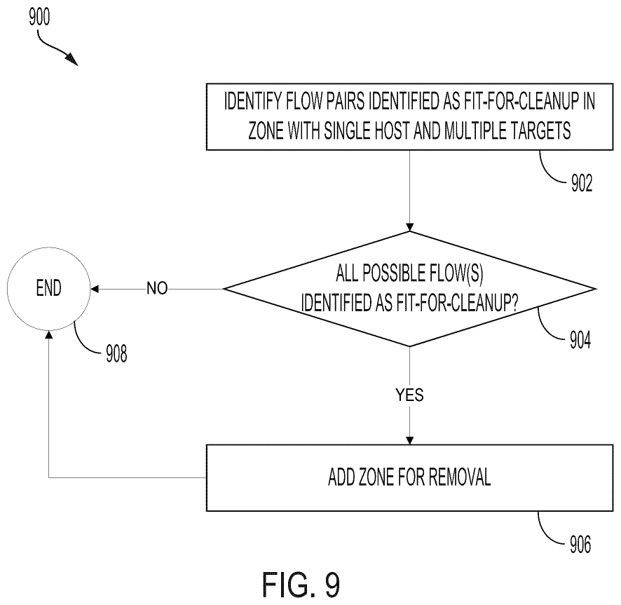

FIG. 9 shows an illustrative example of a process 900 for performing an automatic cleanup of a zone comprising a single host device and multiple target devices in accordance with at least one embodiment. Similar to the process 800 described above in connection with FIG. 8, the process 900 may be performed by any FC module associated with any of the edge switches in the FC fabric. In an embodiment, the process 900 is performed upon expiration of a recurrent timer. This recurrent timer may be similar to the timers described above for the identification of stale and inactive flows from the zoning configuration.

At step 902, the FC module may perform a mapping of the zoning configuration for a zone having a single host device and multiple target devices to identify any (H,T) flow pairs identified as being fit-for-cleanup. Similar to the process 800 described above in connection with FIG. 8, through this mapping, the FC module may evaluate the zoning configuration to potentially identify any (H,T) flow pairs that have been identified as being fit-for-cleanup in the zone. These (H,T) flow pairs may be identified as being fit-for-cleanup through any of the processes described above in connection with FIGS. 2, 4-5, and 7. For instance, an (H,T) flow may be identified as being fit-for-cleanup as a result of the flow being classified as being either stale or inactive within the zoning configuration.

At step 904, the FC module may determine whether all of the (H,T) flows associated with the particular zone have been identified as being fit-for-cleanup. If the FC module determines that not all of the (H,T) flows associated with the zone have been identified as being fit-for-cleanup, the FC module may determine that no cleanup can be performed for this zone until all of the (H,T) flows associated with the zone have been designated as being fit-for-cleanup. Accordingly, if the FC module determines that not all of the (H,T) flows associated with the zone have been identified as being fit-for-cleanup, the process 900 may end at step 908.

If the FC module determines that all of the (H,T) flows associated with the zone have been designated as being fit-for-cleanup, the FC module, at step 906, may add the entire zone for removal from the zoning configuration. Once the zone has been added to a list for removal from the zoning configuration, the process 900 may end at step 908.

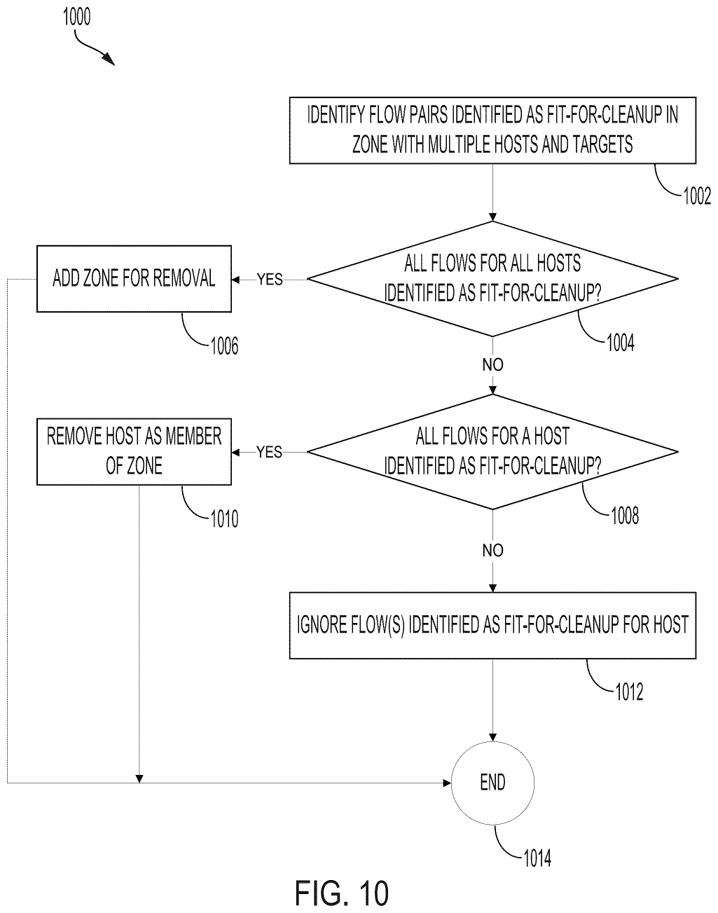

FIG. 10 shows an illustrative example of a process 1000 for performing an automatic cleanup of a zone comprising multiple host devices and multiple target devices in accordance with at least one embodiment. Similar to the processes 800 and 900 described above in connection with FIGS. 8 and 9 respectively, the process 1000 may be performed by any FC module associated with any of the edge switches in the FC fabric. In an embodiment, the process 1000 is performed upon expiration of a recurrent timer. This recurrent timer may be similar to the timers described above for the identification of stale and inactive flows from the zoning configuration.

At step 1002, the FC module may perform a mapping of the zoning configuration for a zone having a multiple target devices and multiple host devices to identify any (H,T) flow pairs designated as being fit-for-cleanup. For instance, through this mapping, the FC module may evaluate the zoning configuration to potentially identify any (H,T) flow pairs that have been identified as being fit-for-cleanup in the zone. These (H,T) flow pairs may be identified as being fit-for-cleanup through any of the processes described above in connection with FIGS. 2, 4-5, and 7.

At step 1004, the FC module may determine whether all of the (H,T) flows for the particular zone and corresponding to all host devices associated with the zone have been identified as being fit-for-cleanup. As with the process 800 described above, whereby a zone including a single target device and multiple host devices is designated for removal as a result of a determination that removal of the identified (H,T) flows would result in the zone including only the target device, the FC module, at step 1006, may designate the zone for removal if all of the (H,T) flows for all of the host devices assigned to the zone are slated for removal from the zoning configuration. Once the zone has been added for removal from the zoning configuration, the process 1000 may end at step 1014.

If the FC module determines that not all (H,T) flows corresponding to all host devices have been identified as being fit-for-cleanup, the FC module may determine, at step 1008, whether all (H,T) flows for a particular host device have been identified as being fit-for-cleanup. As with the process 900 described above, whereby a host device associated with a zone including the single host device and multiple target devices is removed from the zoning configuration only when all (H,T) flows associated with the single host device are slated for removal, if the FC module determines that all (H,T) flows associated with a particular host device are identified as being fit-for-cleanup, the FC module, at step 1010, may remove this host device as a member of the zone within the zoning configuration. Once the host device has been removed as a member of the zone from the zoning configuration, the process 1000 may end at step 1014.

If the FC module determines, for a particular host device, that not all (H,T) flows associated with the particular host device are designated for removal from the zoning configuration, the FC module, at step 1012, may ignore the (H,T) flows associated with this particular host device and designated as being fit-for-cleanup until all (H,T) flows associated with this particular host device are designated as such. The identified (H,T) flows previously designated as being fit-for-cleanup may maintain this designation but are not immediately removed from the zoning configuration until all (H,T) flows associated with the particular host device are designated as being fit-for-cleanup. At this point, the process 1000 may end at step 1014.

In an embodiment, for any identified (H,T) flows that were not removed from the zoning configuration as a result of the identified (H,T) flows being associated with a host device that is not slated for removal from the zone, the FC module can generate a system log (syslog) or a CLI to present a listing of ineffective identified flows. These ineffective identified flows may correspond to any (H,T) flows that are designated as being fit-for-removal but have not been removed as a result of their corresponding host device not being slated for removal from the zone. This syslog or CLI may assist administrators of the FC fabric in separating out their zoning configuration for cleanup of the zoning configuration.

FIG. 11 illustrates an example network device 1100 suitable for performing switching, routing, and other networking operations in accordance with some implementations. Network device 1100 includes a CPU 1104, interfaces 1102, and a connection 1110 (e.g., a Peripheral Component Interconnect (PCI) bus). When acting under the control of appropriate software or firmware, the CPU 1104 is responsible for executing packet management, error detection, and/or routing functions. The CPU 1104 can accomplish these functions under the control of software including an operating system and any appropriate applications software. The CPU 1104 may include one or more processors 1108, such as a processor from the Intel® X98 family of microprocessors. In some cases, the processor 1108 can be specially designed hardware for controlling the operations of network device 1100. In some cases, a memory 1106 (e.g., non-volatile RAM, ROM, etc.) also forms part of the CPU 1104. However, there are many different ways in which memory could be coupled to the system.

The interfaces 1102 are typically provided as modular interface cards (sometimes referred to as “line cards”). Generally, they control the sending and receiving of data packets over the network and sometimes support other peripherals used with the network device 1100. Among the interfaces that may be provided are Ethernet interfaces, frame relay interfaces, cable interfaces, Digital Subscriber Line (DSL) interfaces, token ring interfaces, and the like. In addition, various very high-speed interfaces may be provided such as fast token ring interfaces, wireless interfaces, Ethernet interfaces, Gigabit Ethernet interfaces, Asynchronous Transfer Mode (ATM) interfaces, High-Speed Serial Interface (HSSI) interfaces, Packet Over SONET/SDH (POS) interfaces, Fiber Distributed Data Interface (FDDI) interfaces, WiFi interfaces, 3G/4G/5G cellular interfaces, Controller Area Network (CAN) bus, Long Range (LoRa), and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master microprocessor 1104 to efficiently perform routing computations, network diagnostics, security functions, etc.

Although the system shown in FIG. 11 is one specific network device of the present technologies, it is by no means the only network device architecture on which the present technologies can be implemented. For example, an architecture having a single processor that handles communications as well as routing computations, etc., is often used. Further, other types of interfaces and media could also be used with the network device 1100.

Regardless of the network device's configuration, it may employ one or more memories or memory modules (including memory 1106) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 1106 could also hold various software containers and virtualized execution environments and data.

The network device 1100 can also include an application-specific integrated circuit (ASIC) 1112, which can be configured to perform routing and/or switching operations. The ASIC 1112 can communicate with other components in the network device 1100 via the connection 1110, to exchange data and signals and coordinate various types of operations by the network device 1100, such as routing, switching, and/or data storage operations, for example.

FIG. 12 illustrates a computing system architecture 1200 including various components in electrical communication with each other using a connection 1206, such as a bus, in accordance with some implementations. Example system architecture 1200 includes a processing unit (CPU or processor) 1204 and a system connection 1206 that couples various system components including the system memory 1220, such as ROM 1218 and RAM 1216, to the processor 1204. The system architecture 1200 can include a cache 1202 of high-speed memory connected directly with, in close proximity to, or integrated as part of the processor 1204. The system architecture 1200 can copy data from the memory 1220 and/or the storage device 1208 to the cache 1202 for quick access by the processor 1204. In this way, the cache can provide a performance boost that avoids processor 1204 delays while waiting for data. These and other modules can control or be configured to control the processor 1204 to perform various actions.

Other system memory 1220 may be available for use as well. The memory 1220 can include multiple different types of memory with different performance characteristics. The processor 1204 can include any general purpose processor and a hardware or software service, such as service 1 1210, service 2 1212, and service 3 1214 stored in storage device 1208, configured to control the processor 1204 as well as a special-purpose processor where software instructions are incorporated into the actual processor design. The processor 1204 may be a completely self-contained computing system, containing multiple cores or processors, a bus, memory controller, cache, etc. A multi-core processor may be symmetric or asymmetric.

To enable user interaction with the computing system architecture 1200, an input device 1222 can represent any number of input mechanisms, such as a microphone for speech, a touch-sensitive screen for gesture or graphical input, keyboard, mouse, motion input, speech and so forth. An output device 1224 can also be one or more of a number of output mechanisms known to those of skill in the art. In some instances, multimodal systems can enable a user to provide multiple types of input to communicate with the computing system architecture 1200. The communications interface 1226 can generally govern and manage the user input and system output. There is no restriction on operating on any particular hardware arrangement and therefore the basic features here may easily be substituted for improved hardware or firmware arrangements as they are developed.

Storage device 1208 is a non-volatile memory and can be a hard disk or other types of computer readable media which can store data that are accessible by a computer, such as magnetic cassettes, flash memory cards, solid state memory devices, digital versatile disks, cartridges, RAMs 1216, ROM 1218, and hybrids thereof.

The storage device 1208 can include services 1210, 1212, 1214 for controlling the processor 1204. Other hardware or software modules are contemplated. The storage device 1208 can be connected to the system connection 1206. In one aspect, a hardware module that performs a particular function can include the software component stored in a computer-readable medium in connection with the necessary hardware components, such as the processor 1204, connection 1206, output device 1224, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

1. A computer-implemented method comprising:
in response to determining that a periodic time interval for evaluating stale zoning entries has elapsed:
detecting disconnection of a device from a Fibre Channel (FC) fabric, wherein the FC fabric is associated with a zoning configuration, and wherein the zoning configuration includes indications of devices configured to communicate within a zone;
generating an update to the zoning configuration, wherein the update includes a timestamp corresponding to a time at which the disconnection of the device was detected;
determining, based on the timestamp, that an expiration period corresponding to the disconnection has elapsed, wherein the expiration period is defined according to the time at which the disconnection of the device was detected;
determining that the disconnection of the device is not the result of a scheduled event; and
in response to the expiration period has elapsed and the disconnection is not the result of the scheduled event, automatically determining an entry corresponding to the device from the zoning configuration is a stale entry and removing the entry.

2. The computer-implemented method of claim 1, wherein the update further indicates a fabric port corresponding to the device, and wherein the update is used to remove an FC identifier (FCID) entry corresponding to the device from the FC fabric.

3. The computer-implemented method of claim 1, wherein:
the zone includes the device and a second device within the FC fabric, wherein the device and the second device form a host-target pair associated with the zone; and
the computer-implemented method further comprises automatically removing the zone from the zoning configuration.

4. The computer-implemented method of claim 1, wherein:
the device is a target device associated with a host device from a plurality of host devices within the zone; and
the computer-implemented method further comprises automatically removing an entry corresponding to the host device from the zone.

5. The computer-implemented method of claim 1, further comprising:
determining that removing the entry from the zoning configuration results in the zone having a single target device within the zone; and
automatically removing the zone from the zoning configuration.

6. The computer-implemented method of claim 1, further comprising:
determining that all host devices associated with the zone are removable from the zone; and
automatically removing the zone from the zoning configuration.

7. The computer-implemented method of claim 1, wherein:
the device is a host device associated with a set of target devices within the zone; and
the computer-implemented method further comprises removing the device from the zone as a result of a set of flows corresponding to the host device and the set of target devices being identified for removal.

8. A system, comprising:
one or more processors; and
memory storing thereon instructions that, as a result of being executed by the one or more processors, cause the system to:
in response to determining that a periodic time interval for evaluating stale zoning entries has elapsed:
detect disconnection of a device from a Fibre Channel (FC) fabric, wherein the FC fabric is associated with a zoning configuration, and wherein the zoning configuration includes indications of devices configured to communicate within a zone;
generate an update to the zoning configuration, wherein the update includes a timestamp corresponding to a time at which the disconnection of the device was detected;
determine, based on the timestamp, that an expiration period corresponding to the disconnection has elapsed, wherein the expiration period is defined according to the time at which the disconnection of the device was detected;
determine that the disconnection of the device is not the result of a scheduled event; and
in response to the expiration period has elapsed and the disconnection is not the result of the scheduled event, determine an entry corresponding to the device from the zoning configuration is a stale entry and automatically remove the entry.

9. The system of claim 8, wherein the update further indicates a fabric port corresponding to the device, and wherein the update is used to remove an FC identifier (FCID) entry corresponding to the device from the FC fabric.

10. The system of claim 8, wherein:
the zone includes the device and a second device within the FC fabric, wherein the device and the second device form a host-target pair associated with the zone; and
the instructions further cause the system to automatically remove the zone from the zoning configuration.

11. The system of claim 8, wherein:
the device is a target device associated with a host device from a plurality of host devices within the zone; and
the instructions further cause the system to automatically remove an entry corresponding to the host device from the zone.

12. The system of claim 8, wherein the instructions further cause the system to:
determine that removing the entry from the zoning configuration results in the zone having a single target device within the zone; and
automatically remove the zone from the zoning configuration.

13. The system of claim 8, wherein the instructions further cause the system to:
determine that all host devices associated with the zone are removable from the zone; and
automatically remove the zone from the zoning configuration.

14. The system of claim 8, wherein:
the device is a host device associated with a set of target devices within the zone; and
the instructions further cause the system to remove the device from the zone as a result of a set of flows corresponding to the host device and the set of target devices being identified for removal.

15. A non-transitory, computer-readable storage medium storing thereon executable instructions that, as a result of being executed by one or more processors of a computer system, cause the computer system to:
in response to determining that a periodic time interval for evaluating stale zoning entries has elapsed:
detect disconnection of a device from a Fibre Channel (FC) fabric, wherein the FC fabric is associated with a zoning configuration, and wherein the zoning configuration includes indications of devices configured to communicate within a zone;
generate an update to the zoning configuration, wherein the update includes a timestamp corresponding to a time at which the disconnection of the device was detected;
determine, based on the timestamp, that an expiration period corresponding to the disconnection has elapsed, wherein the expiration period is defined according to the time at which the disconnection of the device was detected;
determine that the disconnection of the device is not the result of a scheduled event; and
in response to the expiration period has elapsed and the disconnection is not the result of the scheduled event, determined an entry corresponding to the device from the zoning configuration is a stale entry and automatically remove the entry.

16. The non-transitory, computer-readable storage medium of claim 15, wherein the update further indicates a fabric port corresponding to the device, and wherein the update is used to remove an FC identifier (FCID) entry corresponding to the device from the FC fabric.

17. The non-transitory, computer-readable storage medium of claim 15, wherein:
the zone includes the device and a second device within the FC fabric, wherein the device and the second device form a host-target pair associated with the zone; and
the executable instructions further cause the computer system to automatically remove the zone from the zoning configuration.

18. The non-transitory, computer-readable storage medium of claim 15, wherein:
the device is a target device associated with a host device from a plurality of host devices within the zone; and
the executable instructions further cause the computer system to automatically remove an entry corresponding to the host device from the zone.

19. The non-transitory, computer-readable storage medium of claim 15, wherein the executable instructions further cause the computer system to:
determine that removing the entry from the zoning configuration results in the zone having a single target device within the zone; and
automatically remove the zone from the zoning configuration.

20. The non-transitory, computer-readable storage medium of claim 15, wherein the executable instructions further cause the computer system to:
determine that all host devices associated with the zone are removable from the zone; and
automatically remove the zone from the zoning configuration.
